(19) United States
(12) Patent Application Publication
(10) Pub. No.: US 2025/0289956 A1
(43) Pub. Date: Sep. 18, 2025

(54) Polymer Composition With Improved Thermal Shock Resistance

(71) Applicant: Ticona LLC, Florence, KY (US)

(72) Inventors: Zhe Tan, Shanghai (CN); Yuehua Yu, Cincinnati, OH (US); Xiaoyan Liu, Shanghai (CN); Wenli Xu, Shanghai (CN); Fangfang Tao, Shanghai (CN)

(21) Appl. No.: 19/062,100

(22) Filed: Feb. 25, 2025

Related U.S. Application Data
(60) Provisional application No. 63/565,573, filed on Mar. 15, 2024.

(51) Int. Cl. C08L 81/02

(52) U.S. Cl. CPC C08L 81/02; C08L 2201/08; C08L 2203/20; C08L 2205/025; C08L 2205/03; C08L 2205/035; C08L 2205/16

(57) ABSTRACT

A polymer composition that comprises an impact modifier, mineral particles, and reinforcing fibers dispersed within a polymer matrix is provided. The polymer matrix contains a polyarylene sulfide and exhibits a melt flow index of from about 500 to about 1,000 grams per 10 minutes. The weight ratio of the reinforcing fibers to the mineral particles is about 2 or more. Further, the polymer composition exhibits a thermal shock resistance value of about 800 or more.

### RELATED APPLICATION

The present application is based upon and claims priority to U.S. Provisional Patent Application Ser. No. 63/565,573, having a filing date of Mar. 15, 2024, which is incorporated herein by reference.

### BACKGROUND OF THE INVENTION

Electric vehicles, such as battery-electric vehicles, plug-in hybrid-electric vehicles, mild hybrid-electric vehicles, or full hybrid-electric vehicles generally have an electric powertrain that contains an electric propulsion source (e.g., battery) and a transmission. High performance polymeric materials are often employed in the electric vehicle for various components, such as in high voltage connectors, power converter housings, battery assembly housings, fluid pumps, inverters, busbars, twisted cables, individual sense lead wires, wire crimps, grommet moldings, quick connectors, tees, interconnects, guide rails, sealing rings (e.g., brushless direct current sealing rings, battery cell sealing rings, etc.), etc. Many of these components are “insert molded” in that they are formed by inserting a member (e.g., metal) into a polymer composition as it is being molded. While this process enables the formation of complex parts, the stark differences in the coefficients of thermal expansion of the different materials can lead to cracking when the part is exposed to changes in temperature. For this reason, various attempts have been made to develop performance polymer compositions with a high degree of thermal shock resistance. Unfortunately, none of the attempts have been able to achieve a sufficiently high degree of thermal shock resistance to allow their use in many EV product applications. As such, a need currently exists for polymer compositions that can exhibit a high degree of thermal shock resistance for use in various applications, such as electric vehicle components.

### SUMMARY OF THE INVENTION

In accordance with one embodiment of the present invention, a polymer composition is disclosed that comprises an impact modifier, mineral particles, and reinforcing fibers dispersed within a polymer matrix. The polymer matrix contains a polyarylene sulfide and exhibits a melt flow index of from about 500 to about 1,000 grams per 10 minutes as determined in accordance with ASTM D1238-13 at a load of 2.16 kg and temperature of 190° C. The weight ratio of the reinforcing fibers to the mineral particles is about 2 or more. Further, the polymer composition exhibits a thermal shock resistance value of about 800 or more.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 illustrates an electric vehicle including components that may incorporate a polymer composition as disclosed herein;

FIG. 2 illustrates one embodiment of a busbar as may incorporate a polymer composition as disclosed herein;

FIG. 3 illustrates a battery assembly that may employ components that may incorporate a polymer composition as disclosed herein;

FIG. 4 illustrates an electronic system as may include components that may incorporate a polymer composition as disclosed herein;

FIG. 5 illustrates a current sensor as may be included in an electronic system as in FIG. 4;

FIG. 6 illustrates an inverter system as may be present in an electric car including components that may incorporate a polymer composition as disclosed herein;

FIG. 7 is a perspective view of one embodiment of a connector that may incorporate a polymer composition as disclosed herein;

FIG. 8 is a plan view of the connector of FIG. 7 in which the first and second connector portions are disengaged;

FIG. 9 is a plan view of the connector of FIG. 7 in which the first and second connector portions are engaged;

FIG. 10 illustrates examples of components that may incorporate a polymer composition as disclosed herein;

FIG. 11 illustrates additional components that may incorporate a polymer composition as disclosed herein;

FIG. 12 illustrates a low temperature thermal loop as may include components that may incorporate a polymer composition as disclosed herein;

FIG. 13 illustrates a high temperature thermal loop as may include components that may incorporate a polymer composition as disclosed herein;

FIG. 14 illustrates one embodiment of a water pump as may incorporate a polymer composition as disclosed herein; and

FIGS. 15-18 illustrates sample components that may be used to perform testing for thermal shock resistance as described herein.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition that may contain an impact modifier, mineral particles, and reinforcing fibers dispersed within a polymer matrix that includes at least one polyarylene sulfide. By selectively controlling the particular components and their relative concentration, it has been discovered that the resulting composition may exhibit improved properties for use in forming components of an electric vehicle, such as a battery-powered electric vehicle, fuel cell-powered electric vehicle, plug-in hybrid-electric vehicle (PHEV), mild hybrid-electric vehicle (MHEV), full hybrid-electric vehicle (FHEV), etc. More particularly, the polymer composition may exhibit a thermal shock resistance value of about 800 or more, in some embodiments about 1,000 or more, in some embodiments about 1,200 or more, in some embodiments about 1,500 or more, in some embodiments about 1,800 or more, in some embodiments about 2,000 or more, and in some embodiments, about 3,000 or more. As used herein, the “thermal shock resistance value” is determined according to the test described below and generally refers to the number of heating cycles a set of sample components is able to withstand without undergoing visual cracking. Such properties may even be achieved at relatively small thickness values, such as about 4 millimeters or less, in some embodiments about from about 0.2 to about 3.2 millimeters, and in some embodiments, from about 0.4 to about 3.0 millimeters (e.g., 0.8, 1.2, 1.5, 2.5, or 3 mm). The polymer composition can also exhibit good flame retardant characteristics as determined according to UL 94 testing as described below. For instance, the polymer composition may achieve at least a V-1 rating, and typically a V-0 rating, for specimens having a thickness such as noted above (e.g., 1.5 millimeters).

While exhibiting good thermal shock resistance and flame retardancy, the composition may still exhibit good flow properties as reflected by a relatively high melt flow index, such as from about 500 to about 1,000 grams per 10 minutes, in some embodiments from about 550 to about 950 grams per 10 minutes, in some embodiments from about 600 to about 900 grams per 10 minutes, and in some embodiments, from about 650 to about 850 grams per 10 minutes, as determined in accordance with ASTM D1238-13 at a load of 2.16 kg and temperature of 190° C. The composition may also exhibit a relatively low melt viscosity, such as about 30 kP or less, in some embodiments about 20 kP or less, in some embodiments about 15 kP or less, and in some embodiments, from about 1 about 10 kP, as determined in accordance with ISO 11443:2021 at a temperature of about 310° C. and at a shear rate of 400 s-1

Despite having good flow properties, the polymer composition may nevertheless maintain a high degree of impact strength as well as tensile strength, which can provide enhanced flexibility for the resulting component. For example, the polymer composition may exhibit a Charpy notched impact strength of about 4 KJ/m² or more, such as in some embodiments from about 5 to about 20 KJ/m², and in some embodiments, from about 8 to about 15 KJ/m², as determined at a temperature of 23° C. in accordance with ISO 179-1:2010. The polymer composition may also exhibit a tensile stress at break of about 100 MPa or more, in some embodiments from about 130 MPa to about 350 MPa, and in some embodiments, from about 160 to about 300 MPa; a tensile break strain of about 1% or more, in some embodiments from about 1.5% to about 5%; and/or a tensile modulus of about 8,000 MPa or more, in some embodiments from about 10,000 MPa to about 25,000 MPa, in some embodiments from about 15,000 MPa to about 20,000 MPa. The tensile properties may be determined in accordance with ISO 527:2019 at a temperature of 23° C. The composition may also exhibit a flexural strength of about 100 MPa or more, in some embodiments from about 150 to about 400 MPa, and in some embodiments from about 200 to about 350 MPa, a flexural break strain of about 1% or more, in some embodiments from about 1.5% to about 5%; and/or a flexural modulus of 8,000 MPa or more, in some embodiments from about 10,000 MPa to about 25,000 MPa, and in some embodiments, from about 15,000 MPa to about 20,000 MPa. The flexural properties may be determined in accordance with ISO 178:2019 at a temperature of 23° C.

The polymer composition may also exhibit good insulative properties. The insulative properties of the polymer composition may be characterized by a high comparative tracking index (“CTI”), such as about 150 volts or more, in some embodiments about 160 volts or more, in some embodiments about 170 volts or more, in some embodiments about 200 volts or more, and in some embodiments, from about 250 volts to about 500 volts, as determined in accordance with IEC 60112:2003. The insulative properties may be achieved at relatively small thickness values, such as noted above.

Various embodiments of the present invention will now be described in greater detail below.

### I. Polymer Composition

### A. Polymer Matrix

The polymer matrix typically constitutes from about 10 wt. % to about 70 wt. %, in some embodiments from about 20 wt. % to about 60 wt. %, in some embodiments from about 25 wt. % to about 55 wt. %, and in some embodiments, from about 30 wt. % to about 50 wt. % of the polymer composition. The polymer matrix contains at least one polyarylene sulfide. For example, polyarylene sulfides typically constitute from about 50 wt. % to 100 wt. %, in some embodiments from about 70 wt. % to 100 wt. %, and in some embodiments, from about 90 wt. % to 100 wt. % of the polymer matrix (e.g., 100 wt. %).

The polyarylene sulfide may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

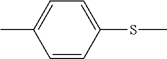

and segments having the structure of formula:

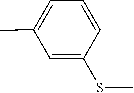

or segments having the structure of formula:

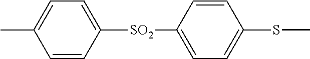

The polyarylene sulfide may be linear, semi-linear, branched, or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

If desired, the polyarylene sulfide can be functionalized. For instance, a disulfide compound containing reactive functional groups (e.g., carboxyl, hydroxyl, amine, etc.) can be reacted with the polyarylene sulfide. Functionalization of the polyarylene sulfide can further provide sites for bonding between any impact modifiers and the polyarylene sulfide, which can improve distribution of the impact modifier throughout the polyarylene sulfide and prevent phase separation. The disulfide compound may undergo a chain scission reaction with the polyarylene sulfide during melt processing to lower its overall melt viscosity. When employed, disulfide compounds typically constitute from about 0.01 wt. % to about 3 wt. %, in some embodiments from about 0.02 wt. % to about 1 wt. %, and in some embodiments, from about 0.05 to about 0.5 wt. % of the polymer composition. The ratio of the amount of the polyarylene sulfide to the amount of the disulfide compound may likewise be from about 1000:1 to about 10:1, from about 500:1 to about 20:1, or from about 400:1 to about 30:1. Suitable disulfide compounds are typically those having the following formula:

R³—S—S—R⁴

wherein R³ and R⁴ may be the same or different and are hydrocarbon groups that independently include from 1 to about 20 carbons. For instance, R³ and R⁴ may be an alkyl, cycloalkyl, aryl, or heterocyclic group. In certain embodiments, R³ and R⁴ are generally nonreactive functionalities, such as phenyl, naphthyl, ethyl, methyl, propyl, etc. Examples of such compounds include diphenyl disulfide, naphthyl disulfide, dimethyl disulfide, diethyl disulfide, and dipropyl disulfide. R³ and R⁴ may also include reactive functionality at terminal end(s) of the disulfide compound. For example, at least one of R³ and R⁴ may include a terminal carboxyl group, hydroxyl group, a substituted or non-substituted amino group, a nitro group, or the like. Examples of compounds may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid (or 2,2′-dithiobenzoic acid), dithioglycolic acid, α,α′-dithiodilactic acid, β,β′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole), 2-(4′-morpholinodithio)benzothiazole, etc., as well as mixtures thereof.

As indicated above, the polymer matrix may exhibit a melt flow index of greater than about 550 grams per 10 minutes, in some embodiments greater than about 600 grams per 10 minutes, in some embodiments from about 650 to about 1,000 grams per 10 minutes, and in some embodiments, from about 700 to about 900 grams per 10 minutes, as determined in accordance with ASTM D1238-13 at a load of 2.16 kg and temperature of 190° C. The target melt flow index may be achieve through the use of a single polyarylene sulfide or through the use of a blend of polyarylene sulfides having different melt flow indices. In one embodiment, for example, the polymer matrix may employ a first polyarylene sulfide having a first melt flow index and a second polyarylene sulfide having a second melt flow index. The ratio of the first melt flow index to the second melt flow index may, for example, be from about 1.5 to about 3, in some embodiments from about 1.6 to about 2.8, and in some embodiments, from about 1.8 to about 2.4. The first melt flow index may, for example, range from about 700 to about 2000, in some embodiments from about 750 to about 1500, and in some embodiments, from about 800 to about 1200 grams per 10 minutes. Likewise, the second melt flow index may range from about 250 to about 700, in some embodiments from about 300 to about 650, and in some embodiments, from about 400 to about 600 grams per 10 minutes. Depending on the exact melt flow indices chosen, the relative weight percentage of each polymer may thus be selectively controlled to achieve the target melt flow index for the polymer matrix. Typically, for example, the first polyarylene sulfide and the second polyarylene sulfide each constitutes from about 30 wt. % to about 70 wt. %, in some embodiments from about 35 wt. % to about 65 wt. %, and in some embodiments, from about 40 wt. % to about 60 wt. % of the polymer matrix.

Polyarylene sulfides, such as described above, typically have a DTUL value of from about 70° C. to about 220° C., in some embodiments from about 90° C. to about 200° C., and in some embodiments, from about 120° C. to about 180° C. as determined in accordance with ISO 75-2:2013 at a load of 1.8 MPa. The polyarylene sulfides likewise typically have a glass transition temperature of from about 50° C. to about 120° C., in some embodiments from about 60° C. to about 115° C., and in some embodiments, from about 70° C. to about 110° C., as well as a melting temperature of from about 220° C. to about 340° C., in some embodiments from about 240° C. to about 320° C., and in some embodiments, from about 260° C. to about 300° C.

### B. Impact Modifier

As noted above, the polymer composition may also contain an impact modifier. Such impact modifier(s) typically constitute from about 1 to about 30 parts, in some embodiments from about 2 to about 20 parts, and in some embodiments, from about 5 to about 15 parts by weight per 100 parts by weight of the polymer matrix. For example, the impact modifiers may constitute from about 0.1 wt. % to about 20 wt. %, in some embodiments from about 0.5 wt. % to about 15 wt. %, and in some embodiments, from about 1 wt. % to about 10 wt. % of the polymer composition.

Examples of suitable impact modifiers may include, for instance, polyepoxides, polyurethanes, polybutadiene, acrylonitrile-butadiene-styrene, polyamides, block copolymers (e.g., polyether-polyamide block copolymers), etc., as well as mixtures thereof. In one embodiment, an olefin copolymer is employed that is “epoxy-functionalized” in that it contains, on average, two or more epoxy functional groups per molecule. The copolymer generally contains an olefinic monomeric unit that is derived from one or more α-olefins. Examples of such monomers include, for instance, linear and/or branched α-olefins having from 2 to 20 carbon atoms and typically from 2 to 8 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired a-olefin monomers are ethylene and propylene. The copolymer may also contain an epoxy-functional monomeric unit. One example of such a unit is an epoxy-functional (meth)acrylic monomeric component. As used herein, the term “(meth)acrylic” includes acrylic and methacrylic monomers, as well as salts or esters thereof, such as acrylate and methacrylate monomers. For example, suitable epoxy-functional (meth) acrylic monomers may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate. Other suitable monomers may also be employed to help achieve the desired molecular weight.

Of course, the copolymer may also contain other monomeric units as is known in the art. For example, another suitable monomer may include a (meth)acrylic monomer that is not epoxy-functional. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In one particular embodiment, for example, the copolymer may be a terpolymer formed from an epoxy-functional (meth)acrylic monomeric component, a-olefin monomeric component, and non-epoxy functional (meth)acrylic monomeric component. The copolymer may, for instance, be poly(ethylene-co-butylacrylate-co-glycidyl methacrylate), which has the following structure:

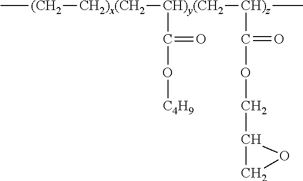

wherein, x, y, and z are 1 or greater.

The relative portion of the monomeric component(s) may be selected to achieve a balance between epoxy-reactivity and melt flow rate. More particularly, high epoxy monomer contents can result in good reactivity with the polyarylene sulfide, but too high of a content may reduce the melt flow rate to such an extent that the copolymer adversely impacts the melt strength of the polymer blend. Thus, in most embodiments, the epoxy-functional (meth)acrylic monomer(s) constitute from about 1 wt. % to about 20 wt. %, in some embodiments from about 2 wt. % to about 15 wt. %, and in some embodiments, from about 3 wt. % to about 10 wt. % of the copolymer. The a-olefin monomer(s) may likewise constitute from about 55 wt. % to about 95 wt. %, in some embodiments from about 60 wt. % to about 90 wt. %, and in some embodiments, from about 65 wt. % to about 85 wt. % of the copolymer. When employed, other monomeric components (e.g., non-epoxy functional (meth)acrylic monomers) may constitute from about 5 wt. % to about 35 wt. %, in some embodiments from about 8 wt. % to about 30 wt. %, and in some embodiments, from about 10 wt. % to about 25 wt. % of the copolymer. The resulting melt flow rate is typically from about 1 to about 30 grams per 10 minutes (“g/10 min”), in some embodiments from about 2 to about 20 g/10 min, and in some embodiments, from about 3 to about 15 g/10 min, as determined in accordance with ASTM D1238-13 at a load of 2.16 kg and temperature of 190° C.

If desired, additional impact modifiers may also be employed in combination with the epoxy-functional impact modifier. For example, the additional impact modifier may include a block copolymer in which at least one phase is made of a material that is hard at room temperature but fluid upon heating and another phase is a softer material that is rubber-like at room temperature. For instance, the block copolymer may have an A-B or A-B-A block copolymer repeating structure, where A represents hard segments and B is a soft segment. Non-limiting examples of impact modifiers having an A-B repeating structure include polyamide/polyether, polysulfone/polydimethylsiloxane, polyurethane/polyester, polyurethane/polyether, polyester/polyether, polycarbonate/polydimethylsiloxane, and polycarbonate/polyether. Triblock copolymers may likewise contain polystyrene as the hard segment and either polybutadiene, polyisoprene, or polyethylene-co-butylene as the soft segment. Similarly, styrene butadiene repeating co-polymers may be employed, as well as polystyrene/polyisoprene repeating polymers. In one particular embodiment, the block copolymer may have alternating blocks of polyamide and polyether. Such materials are commercially available, for example from Atofina under the PEBAX™ trade name. The polyamide blocks may be derived from a copolymer of a diacid component and a diamine component or may be prepared by homopolymerization of a cyclic lactam. The polyether block may be derived from homo-or copolymers of cyclic ethers such as ethylene oxide, propylene oxide, and tetrahydrofuran.

### C. Mineral Particles

As indicated, mineral particles are also employed in the polymer composition. Such particles are typically present in an amount of from about 10 to about 50 parts by weight, in some embodiments from about 15 to about 45 parts by weight, and in some embodiments, from about 20 to about 40 parts by weight per 100 parts by weight of the polymer matrix. Various types of mineral particles may be employed as is known in the art. Clay minerals, for instance, may be particularly suitable for use in the present invention. Examples of such clay minerals include, for instance, talc, halloysite, kaolinite, illite, montmorillonite, vermiculite, palygorskite, pyrophyllite, etc., as well as combinations thereof. In lieu of, or in addition to, clay minerals, still other mineral particles may also be employed, such as metal silicate particles (e.g., calcium silicate, aluminum silicate, mica, diatomaceous earth, wollastonite, and so forth); alkaline earth metal carbonate particles; etc. When employed, for example, the alkaline earth metal carbonate particles may be selected from calcium carbonate, magnesium carbonate, calcium magnesium carbonate, barium carbonate, etc. Such carbonates may be derived from a natural source, such as marble, chalk, limestone, dolomite, etc. Regardless of the particular material, the mineral particles typically have a median particle size in the range of about 0.5 to about 10 micrometers, in some embodiments from about 0.6 to about 8 micrometers, and in some embodiments, from about 1 to about 5 micrometers, such as determined such as determined using by a sedigraph (e.g., SediGraph III 5120 from Micromeritics) and/or using laser diffraction techniques in accordance with ISO 13320:2020 (e.g., with a Horiba LA-960 particle size distribution analyzer). In certain embodiments, the particles may also have a generally spherical shape in that they have an aspect ratio (e.g., average length or diameter divided by average thickness) near 1, such as from about 0.6 to about 2.0, in some embodiments from about 0.7 to about 1.5, and in some embodiments, from about 0.8 to about 1.2.

The mineral particles may have a relatively low moisture content, such as about 0.5 wt. % or less, in some embodiments about 0.3 wt. % or less, and in some embodiments, about 0.2 wt. % or less. The “moisture content” may be determined by measuring the loss of weight after drying the particles in an oven at 110° C. to constant weight (that is dried to dryness at 110° C.).

Although not required, the particles may also contain a surface treatment agent to help facilitate dispersion and compatibility with the polymer matrix. Suitable surface treatment agents may include, for instance, aliphatic carboxylic acids having from 10 to 24 carbon atoms in their chain (e.g., stearic acid, palmitic acid, montanic acid, capric acid, lauric acid, myristic acid, isostearic acid, cerotic acid, and mixtures thereof. When employed, the surface treatment agent can become chemisorbed onto the particles to facilitate dispersion in the polymer matrix. Fatty acids (e.g., stearic acid), for example, may react with alkaline earth metal carbonates (e.g., calcium carbonate) to form a chemisorbed coating thereon (e.g., calcium stearate). To maintain a low moisture content, the surface treatment may be carried out in a dry atmosphere containing a surface treatment agent as a liquid (e.g. as droplets) in a vessel heated indirectly, e.g. by a heating jacket, e.g. containing a heating fluid, e.g. heating oil. The temperature of the atmosphere in the vessel may be varied and controlled so that a selected atmosphere reaction temperature may be chosen and monitored. The vessel may comprise an elongated heated cylindrical structure. Desirably, the target temperature is maintained throughout the region where the surface treatment agent is applied and exits from that region, such as from about 80° C. to about 300° C., and in some embodiments, from about 100° C. to about 200° C. The resulting surface-treated particles may have a moisture content within the ranges noted above, or they may be further dried to achieve the desired moisture content.

### D. Reinforcing Fibers

Reinforcing fibers may also be employed in certain embodiments of the present invention. Any of a variety of different types of reinforcing fibers may generally be employed, such as polymer fibers, metal fibers, carbonaceous fibers (e.g., graphite, carbide, etc.), inorganic fibers, etc., as well as combinations thereof. Inorganic fibers may be particularly suitable, such as those that are derived from glass; titanates (e.g., potassium titanate); silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Glass fibers may be particularly suitable, such as those formed from E-glass, A-glass, C-glass, D-glass, AR-glass, R-glass, S1-glass, S2-glass, etc., as well as mixtures thereof. If desired, the reinforcing fibers may be provided with a sizing agent or other coating as is known in the art. Regardless of the particular type selected, it is generally desired that the fibers have a relatively low elastic modulus to enhance the processability of the resulting polymer composition. The fibers may, for instance, have a Young's modulus of elasticity of less than about 76 GPa, in some embodiments less than about 75 GPa, and in some embodiments, from about 10 to about 74 GPa, as determined in accordance with ASTM C1557-14.

If desired, at least a portion of the reinforcing fibers may have a relatively flat cross-sectional dimension in that they have an aspect ratio of from about 1.5 to about 10, in some embodiments from about 2 to about 8, and in some embodiments, from about 3 to about 5. The aspect ratio is determined by dividing the cross-sectional width of the fibers (i.e., in the direction of the major axis) by the cross-sectional thickness of the fibers (i.e., in the direction of the minor axis). The shape of such fibers may be in the form of an ellipse, rectangle, rectangle with one or more rounded corners, etc. The cross-sectional width of the fibers may be from about 1 to about 50 micrometers, in some embodiments from about 5 to about 45 micrometers, and in some embodiments, from about 10 to about 35 micrometers. The fibers may also have a thickness of from about 0.5 to about 30 micrometers, in some embodiments from about 1 to about 20 micrometers, and in some embodiments, from about 3 to about 15 micrometers. It should be understood that the cross-sectional thickness and/or width need not be uniform over the entire cross-section. In such circumstances, the cross-sectional width is considered as the largest dimension along the major axis of the fiber and the cross-sectional thickness is considered as the largest dimension along the minor axis. For example, the cross-sectional thickness for an elliptical fiber is the minor diameter of the ellipse.

The reinforcing fibers may also have a narrow size distribution. That is, at least about 60% by volume of the fibers, in some embodiments at least about 70% by volume of the fibers, and in some embodiments, at least about 80% by volume of the fibers may have a width and/or thickness within the ranges noted above. The fibers may be endless or chopped fibers, such as those having a length of from about 1 to about 15 millimeters, and in some embodiments, from about 2 to about 6 millimeters. The dimension of the fibers (e.g., length, width, and thickness) may be determined using known optical microscopy techniques.

When employed, the amount of reinforcing fibers may be selectively controlled to achieve the desired combination of properties. The reinforcing fibers may, for example, be employed in an amount of from about 50 to about 150 parts, in some embodiments from about 60 to about 125 parts, and in some embodiments, from about 70 to about 120 parts per 100 parts by weight of the polymer matrix. The reinforcing fibers may, for instance, constitute from about 10 wt. % to about 60 wt. %, in some embodiments from about 20 wt. % to about 50 wt. %, and in some embodiments, from about 25 wt. % to about 45 wt. % of the polymer composition. The relative proportion of the reinforcing fibers to the mineral particles may also be selectively controlled. For example, the weight ratio of the reinforcing fibers to such particles may be from about 2 or more, in some embodiments from about 2.5 to about 8, and in some embodiments, from about 3 to about 6.

### E. Optional Components

In addition to the components noted above, the polymer composition may also contain a variety of other optional components to help improve its overall properties. In one embodiment, for instance, a siloxane polymer may be employed in the polymer composition. Such siloxane polymer(s) typically constitute from about 0.1 to about 10 parts, in some embodiments from about 0.2 to about 5 parts, and in some embodiments, from about 0.5 to about 4 parts by weight per 100 parts by weight of the polymer matrix. For example, siloxane polymer(s) may constitute from about 0.05 wt. % to about 5 wt. %, in some embodiments from about 0.1 wt. % to about 4 wt. %, and in some embodiments, from about 0.5 wt. % to about 2 wt. % of the polymer composition. The siloxane polymer generally has a high molecular weight, such as a weight average molecular weight of about 100,000 grams per mole or more, in some embodiments about 200,000 grams per mole or more, and in some embodiments, from about 500,000 grams per mole to about 2,000,000 grams per mole. The siloxane polymer may also have a relatively high kinematic viscosity at 25° C., such as about 10,000 centistokes or more, in some embodiments about 30,000 centistokes or more, and in some embodiments, from about 50,000 to about 50×10⁶ centistokes, such as from about 1×10⁶ to 50×10⁶ centistokes. The viscosity of a siloxane polymer can be determined according to ASTM D445-21.

Any of a variety of high molecular weight siloxane polymers may generally be employed in the polymer composition. A high molecular weight siloxane polymer generally includes siloxane-based monomer residue repeating units. As used herein, “siloxane” denotes a monomer residue repeat unit having the structure:

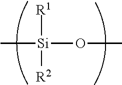

where R¹ and R² are independently hydrogen or a hydrocarbyl moiety, which is known as an “M” group in silicone chemistry.

The silicone may include branch points such as

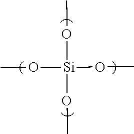

which is known as a “Q” group in silicone chemistry, or

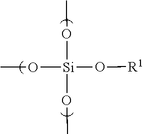

which is known as “T” group in silicone chemistry.

As used herein, the term “hydrocarbyl” denotes a univalent group formed by removing a hydrogen atom from a hydrocarbon (e.g., alkyl groups, such as ethyl, or aryl groups, such as phenyl). In one or more embodiments, a siloxane monomer residue can be any dialkyl, diaryl, dialkaryl, or diaralkyl siloxane, having the same or differing alkyl, aryl, alkaryl, or aralkyl moieties. In an embodiment, each of R¹ and R² is independently a C₁ to C₂₀, C₁ to C₁₂, or C₁ to C₆ alkyl (e.g., methyl, ethyl, propyl, butyl, etc.), aryl (e.g., phenyl), alkaryl,,aralkyl, cycloalkyl (e.g., cyclopentyl), arylenyl, alkenyl, cycloalkenyl (e.g., cyclohexenyl), alkoxy (e.g., methoxy), etc., as well as combinations thereof. In various embodiments, R¹ and R² can have the same or a different number of carbon atoms. In various embodiments, the hydrocarbyl group for each of R¹ and R² is an alkyl group that is saturated and optionally straight-chain. Additionally, the alkyl group in such embodiments can be the same for each of R¹ and R² of a polymer chain. Non-limiting examples of alkyl groups suitable for use in R¹ and R² include methyl, ethyl, 1-propyl, 2-propyl, 1-butyl, isobutyl, t-butyl, or combinations of two or more thereof.

Additionally, the siloxane polymer can contain various terminating groups as an R¹ and/or R² group, such as vinyl groups, hydroxyl groups, hydrides, isocyanate groups, epoxy groups, acid groups, halogen atoms, alkoxy groups, acyloxy groups, ketoximate groups, amino groups, amido groups, acid amido groups, amino-oxy groups, mercapto groups, alkenyloxy groups, alkoxyalkoxy groups, or aminoxy groups as well as combinations thereof. Additionally, a polymer composition can include a mixture of two or more siloxane polymers.

In some embodiments, a high molecular weight siloxane polymer can be proved by copolymerizing multiple siloxane polymers having a low weight average molecular weight (e.g., a molecular weight of less than 100,000 grams per mole) with polysiloxane linkers. In one particular embodiment, for instance, the resin may be formed by copolymerizing one or more low molecular siloxane polymer(s) with a linear polydiorganosiloxane linker, such as described in U.S. Pat. No. 6,072,012 to Juen, et al. A substantially linear polydiorganosiloxane linker may have the following general formula:

(R³₍₃₋ₚ₎R⁴ₚSiO_{1/2})(R³₂SiO_{2/2})ₓ((R³R⁴SiO_{2/2})(R³₂SiO_{2/2})ₓ)_{y}(R³₍₃₋ₚ₎R⁴ₚSiO_{1/2})

wherein,
each R³ is a monovalent group independently selected from the group consisting of alkyl, aryl, and arylalkyl groups;
each R⁴ is a monovalent group independently selected from the group consisting of hydrogen, hydroxyl, alkoxy, oximo, alkyloximo, and aryloximo groups, wherein at least two R⁵ groups are typically present in each molecule and bonded to different silicon atoms;
p is 0, 1, 2, or 3;
x ranges from 0 to 200, and in some embodiments, from 0 to 100; and
y ranges from 0 to 200, and in some embodiments, from 0 to 100.

In certain embodiments, the siloxane polymer may be provided in the form of a masterbatch that includes a carrier resin. The carrier resin may, for instance, constitute from about 0.05 wt. % to about 15 wt. %, in some embodiments from about 0.1 wt. % to about 10 wt. %, and in some embodiments, from about 0.5 wt. % to about 8 wt. % of the polymer composition. Any of a variety of carrier resins may be employed, such as polyolefins (ethylene polymer, propylene polymers, etc.), polyamides, etc. In one embodiment, for example, the carrier resin is an ethylene polymer. The ethylene polymer may be a copolymer of ethylene and an α-olefin, such as a C₃-C₂₀ α-olefin or C₃-C₁₂ α-olefin. Suitable a-olefins may be linear or branched (e.g., one or more C₁-C₃ alkyl branches, or an aryl group). Specific examples include 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin comonomers are 1-butene, 1-hexene and 1-octene. The ethylene content of such copolymers may be from about 60 mole % to about 99 mole %, in some embodiments from about 80 mole % to about 98.5 mole %, and in some embodiments, from about 87 mole % to about 97.5 mole %. The a-olefin content may likewise range from about 1 mole % to about 40 mole %, in some embodiments from about 1.5 mole % to about 15 mole %, and in some embodiments, from about 2.5 mole % to about 13 mole %. The density of the ethylene polymer may vary depending on the type of polymer employed, but generally ranges from about 0.85 to about 0.96 grams per cubic centimeter (g/cm³). Polyethylene “plastomers”, for instance, may have a density in the range of from about 0.85 to about 0.91 g/cm³. Likewise, “linear low density polyethylene” (LLDPE) may have a density in the range of from about 0.91 to about 0.940 g/cm³; “low density polyethylene” (LDPE) may have a density in the range of from about 0.910 to about 0.940 g/cm³; and “high density polyethylene” (HDPE) may have density in the range of from about 0.940 to about 0.960 g/cm³, such as determined in accordance with ASTM D792. Some non-limiting examples of high molecular weight siloxane polymer masterbatches that may be employed include, for instance, those available from Dow Corning under the trade designations MB50-001, MB50-002, MB50-313, MB50-314 and MB50-321.

If desired, an organosilane compound may also be employed in the polymer composition, such as in an amount of from about 0.1 to about 8 parts, in some embodiments from about 0.3 to about 5 parts, and in some embodiments, from about 0.5 to about 3 parts by weight per 100 parts by weight of the polyarylene sulfide(s). For example, organosilane compounds can constitute from about 0.01 wt. % to about 3wt. %, in some embodiments from about 0.05 wt. % to about 2 wt. %, and in some embodiments, from about 0.1 to about 1 wt. % of the polymer composition. The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

R⁵—Si—(R⁶)₃,

wherein,

R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth;

R⁶ is an alkoxy group of from 1 to 10 carbon atoms, such as methoxy, ethoxy, propoxy, and so forth.

Some representative examples of organosilane compounds that may be included in the mixture include mercaptopropyl trimethyoxysilane, mercaptopropyl triethoxysilane, aminopropyl triethoxysilane, aminoethyl triethoxysilane, aminopropyl trimethoxysilane, aminoethyl trimethoxysilane, ethylene trimethoxysilane, ethylene triethoxysilane, ethyne trimethoxysilane, ethyne triethoxysilane, aminoethylaminopropyltrimethoxysilane, 3-aminopropyl triethoxysilane, 3-aminopropyl trimethoxysilane, 3-aminopropyl methyl dimethoxysilane or 3-aminopropyl methyl diethoxysilane, N-(2-aminoethyl)-3-aminopropyl trimethoxysilane, N-methyl-3-aminopropyl trimethoxysilane, N-phenyl-3-aminopropyl trimethoxysilane, bis(3-aminopropyl) tetramethoxysilane, bis(3-aminopropyl) tetraethoxy disiloxane, γ-aminopropyltrimethoxysilane, γ-aminopropyltriethoxysilane, γ-aminopropylmethyldimethoxysilane, γ-aminopropylmethyldiethoxysilane, N-(β-aminoethyl)-γ-aminopropyltrimethoxysilane, N-phenyl-γ-aminopropyltrimethoxysilane, γ-diallylaminopropyltrimethoxysilane, γ-diallylaminopropyltrimethoxysilane, etc., as well as combinations thereof. Particularly suitable organosilane compounds are 3-aminopropyltriethoxysilane and 3-mercaptopropyltrimethoxysilane.

Still other components that can be included in the composition may include, for instance, metal hydroxide particles (e.g., alumina trihydrate), pigments (e.g., black pigments), antioxidants, stabilizers, crosslinking agents, surfactants, waxes, flow promoters, solid solvents, and other materials added to enhance properties and processability.

### II. Melt Processing

The manner in which the polyarylene sulfide(s), impact modifier, mineral particles, reinforcing fibers, and various other optional additives are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 100° C. to about 500° C., and in some embodiments, from about 150° C. to about 300° C. Likewise, the apparent shear rate during melt processing may range from about 100 seconds⁻¹ to about 10,000 seconds⁻¹, and in some embodiments, from about 500 seconds⁻¹ to about 1,500 seconds⁻¹. Of course, other variables, such as the residence time during melt processing, which is inversely proportional to throughput rate, may also be controlled to achieve the desired degree of homogeneity.

If desired, one or more distributive and/or dispersive mixing elements may be employed within the mixing section of the melt processing unit. Suitable distributive mixers may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers. The speed of the screw can also be controlled to improve the characteristics of the composition. For instance, the screw speed can be about 400 rpm or less, in one embodiment, such as between about 200 rpm and about 350 rpm, or between about 225 rpm and about 325 rpm. In one embodiment, the compounding conditions can be balanced so as to provide a polymer composition that exhibits improved properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally, it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs. In one embodiment, a system can include a medium to aggressive screw design with relatively mild screw speeds (e.g., between about 200 rpm and about 300 rpm).

The crystallization temperature of the resulting polymer composition (prior to being formed into a shaped part) may be about 250° C. or less, in some embodiments from about 100° C. to about 245° C., and in some embodiments, from about 150° C. to about 240° C. The melting temperature of the polymer composition may also range from 140° C. to about 380° C., in some embodiments from about 200° C. to about 360° C., in some embodiments from about 250° C. to about 320° C., and in some embodiments, from about 260° C. to about 300° C. The melting and crystallization temperatures may be determined as is well known in the art using differential scanning calorimetry in accordance with ISO 11357-3:2018.

### III. Shaped Part

A shaped part may be formed from the polymer composition using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer composition for a desired time period to allow for solidification. The molded product may then be solidified by bringing it to a temperature below that of the melting temperature. The resulting product may be de-molded. The cycle time for each molding process may be adjusted to suit the polymer composition, to achieve sufficient bonding, and to enhance overall process productivity.

### IV. Composite Structure

As indicated above, the unique properties of the polymer composition can more readily allow it to be integrally formed with a metal component having a vastly different thermal coefficient of expansion. Thus, if desired, the polymer composition may be employed in a composite structure that contains a metal component that is integrally formed and in contact with a resinous component that includes the polymer composition of the present invention. This may be accomplished using a variety of techniques, such as by an insert molding process in which the polymer composition is molded (e.g., injection molded) onto a portion or the entire surface of the metal component. The metal component may contain any of a variety of different metals, such as aluminum, stainless steel, magnesium, nickel, chromium, copper, titanium, and alloys thereof. Due to its unique properties, the polymer composition can adhere to the metal component by flowing within and/or around surface indentations or pores of the metal component. To improve adhesion, the metal component may optionally be pretreated to increase the degree of surface indentations and surface area. This may be accomplished using mechanical techniques (e.g., sandblasting, grinding, flaring, punching, molding, etc.) and/or chemical techniques (e.g., etching, anodic oxidation, etc.). In addition to pretreating the surface, the metal component may also be preheated at a temperature close to, but below the melt temperature of the polymer composition. This may be accomplished using a variety of techniques, such as contact heating, radiant gas heating, infrared heating, convection or forced convection air heating, induction heating, microwave heating or combinations thereof. In any event, the polymer composition is generally injected into a mold that contains the optionally preheated metal component.

### V. Electrical Vehicle

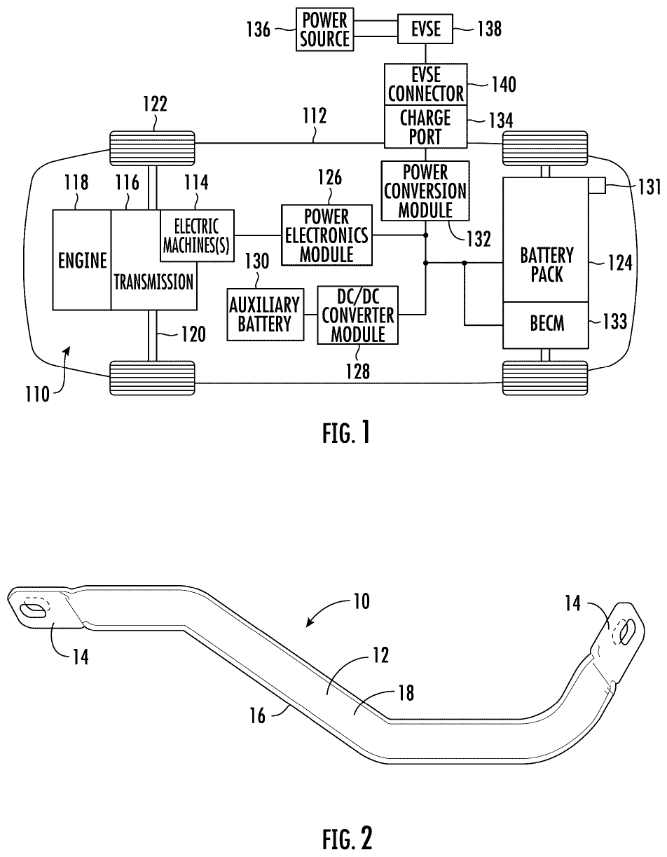

As previously mentioned, the polymer composition, shaped part, and/or composite structure are particularly beneficial for use in components of an electric vehicle. Referring to FIG. 1, for instance, one embodiment of an electric vehicle 112 that includes a powertrain 110 is shown. The powertrain 110 contains one or more electric machines 114 connected to a transmission 116, which in turn is mechanically connected to a drive shaft 120 and drive wheels 122. Although by no means required, the transmission 116 in this particular embodiment is also connected to an engine 118, though the description herein is equally applicable to a pure electric vehicle. The electric machines 114 may be capable of operating as a motor or a generator to provide propulsion and deceleration capability. The powertrain 110 also includes a propulsion source, such as a battery assembly 124, which stores and provides energy for use by the electric machines 114. The battery assembly 124 typically provides a high voltage current output (e.g., DC current at a voltage of from about 400 volts to about 800 volts) from one or more battery cell arrays that may include one or more battery cells.

The powertrain 110 may also contain at least one power electronics module 126 that is connected to the battery assembly 124 (also commonly referred to as a battery pack) and that may contain a power converter (e.g., converter, etc., as well as combinations thereof). The power electronics module 126 is typically electrically connected to the electric machines 114 and provides the ability to bi-directionally transfer electrical energy between the battery assembly 124 and the electric machines 114. For example, the battery assembly 124 may provide a DC voltage while the electric machines 114 may require a three-phase AC voltage to function. The power electronics module 126 may convert the DC voltage to a three-phase AC voltage as required by the electric machines 114. In a regenerative mode, the power electronics module 126 may convert the three-phase AC voltage from the electric machines 114 acting as generators to the DC voltage required by the battery assembly 124. The battery assembly 124 may also provide energy for other vehicle electrical systems. For example, the powertrain may employ a DC/DC converter module 128 that converts the high voltage DC output from the battery assembly 124 to a low voltage DC supply that is compatible with other vehicle loads, such as compressors and electric heaters. In a typical vehicle, the low-voltage systems are electrically connected to an auxiliary battery 130 (e.g., 12V battery). A battery energy control module (BECM) 133 may also be present that is in communication with the battery assembly 124 that acts as a controller for the battery assembly 124 and may include an electronic monitoring system that manages temperature and charge state of each of the battery cells. The battery assembly 124 may also have a temperature sensor 131, such as a thermistor or other temperature gauge. The temperature sensor 131 may be in communication with the BECM 133 to provide temperature data regarding the battery assembly 124. The temperature sensor 131 may also be located on or near the battery cells within the traction battery 124. It is also contemplated that more than one temperature sensor 131 may be used to monitor temperature of the battery cells.

In certain embodiments, the battery assembly 124 may be recharged by an external power source 136, such as an electrical outlet. The external power source 136 may be electrically connected to electric vehicle supply equipment (EVSE) that regulates and manages the transfer of electrical energy between the power source 136 and the vehicle 112. The EVSE 138 may have a charge connector 140 for plugging into a charge port 134 of the vehicle 112. The charge port 134 may be any type of port configured to transfer power from the EVSE 138 to the vehicle 112 and may be electrically connected to a charger or on-board power conversion module 132. The power conversion module 132 may condition the power supplied from the EVSE 138 to provide the proper voltage and current levels to the battery assembly 124. The power conversion module 132 may interface with the EVSE 138 to coordinate the delivery of power to the vehicle 112.

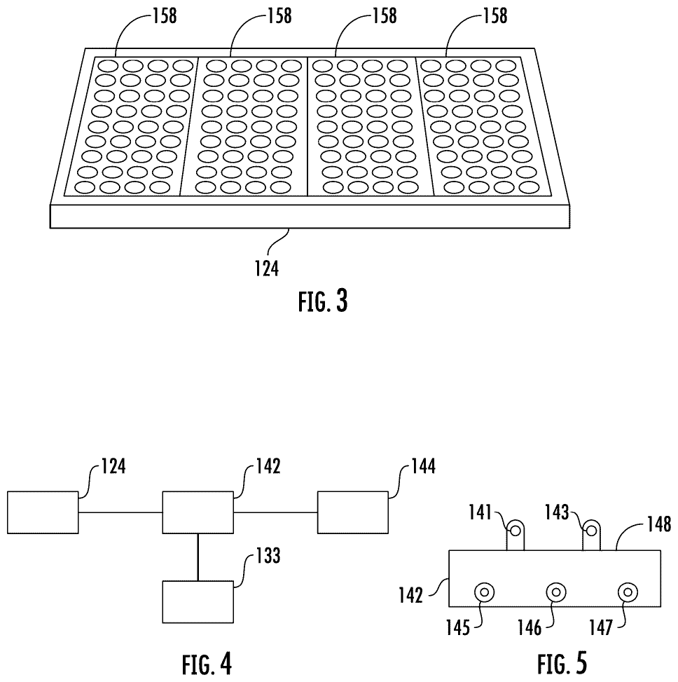

The polymer composition described herein can be included in various components of an electric vehicle as illustrated in FIG. 1. For instance, a busbar, one example of which is illustrated in FIG. 2, may be used to electrically connect individual cells of the battery assembly 124. Referring to FIG. 3, for example, the battery assembly 124 can include a number of battery cells 158. The battery cells 158 may be stacked side-by-side to construct a grouping of battery cells, sometimes referred to as a battery array. In one embodiment, the battery cells 158 are prismatic, lithium-ion cells. However, battery cells having other geometries (cylindrical, pouch, etc.) and/or chemistries (nickel-metal hydride, lead-acid, etc.) could alternatively be utilized within the scope of this disclosure. Each battery cell 158 includes a positive terminal (designated by the symbol (+)) and a negative terminal (designed by the symbol (−)). The battery cells 158 are arranged such that each battery cell 158 terminal is disposed adjacent to a terminal of an adjacent battery cell 158 having an opposite polarity. As used herein, the terms “battery”, “cell”, and “battery cell” may be used interchangeably to refer to any type of individual battery element used in a battery system. The batteries described herein typically include lithium-based batteries, but may also include various chemistries and configurations including iron phosphate, metal oxide, lithium-ion polymer, nickel metal hydride, nickel cadmium, nickel-based batteries (hydrogen, zinc, cadmium, etc.), and any other battery type compatible with an electric vehicle. For example, some embodiments may use the 6831 NCR 18650 battery cell from Panasonic®, or some variation on the 18650 form-factor of 6.5 cm×1.8 cm and approximately 45 g.

The manner in which a busbar connects to individual battery cells of a battery assembly 124, such as shown in FIG. 3, may vary as is known in the art. Referring to FIG. 2, one embodiment of a busbar 10 is shown that includes a conductive body 12. The body 12 includes a conductive material 18, such as copper, aluminum, aluminum alloy, etc., and can generally be in the form of a solid bar, hollow tube, and so forth. The busbar 10 includes a connector portion 14 at either end that is configured to mate with respective terminations of two or more batteries. An insulative portion 16 (e.g., coating or molded material) that includes the polymer composition as described herein may cover a portion of the conductive material of the body 12. To form the busbar 10, the insulative portion 16 can be applied to the surface of the conductive material 18. For instance, a bar or tube of the conductive material 18 can be inserted into a pre-formed tube of the insulating coating 16, e.g., an extruded tube sized and cut to the correct proportions, following which the busbar 10 can be shaped to any suitable form. In another embodiment, the insulating coating can be applied to the surface of the conductive material 18 in the melt, and can solidify on the surface of the conductive material in the applied areas.

Of course, a busbar may be provided in any suitable shape and size. For instance, a busbar may be used as a template for placing the individual battery cells so that they are uniform in each battery assembly manufactured. In such an embodiment, a busbar may hold individual batteries of a battery assembly 124 in place during the manufacturing process and thermal padding or injection-housings, which can be formed of a polymer composition as described herein, can be added without causing the individual battery cells to shift out of position.

Apart from busbars, other components may also employ the polymer composition of the present invention. For instance, FIG. 4 presents a block diagram of battery electronics of an electric vehicle 112. The illustrated battery electronics system includes a battery assembly 124 and a current sensor 142. As shown, current sensor 142 is connected between battery assembly 124 and load/source 144. The current sensor 142 can be configured to measure the current flowing from the battery assembly 124 to the load/source 144 when load/source 144 is a load such as one or more electric machines 114. Likewise, current sensor 142 can be configured to measure the current flowing to battery assembly 124 from load/source 144 when the load/source 144 is a source such as an external power source 136. The (BECM) 133 can be configured to power current sensor 142 to enable its operation. The BECM 133 can further be configured to read an output generated by current sensor 142 which is indicative of the current flowing between battery assembly 124 and load/source 144.

FIG. 5 illustrates one embodiment of a current sensor 142. A current sensor 142 can include a current in port 141 and a current out port 143 as well as standard ground 145, voltage at common collector (VCC) 146, and output port(s) 147. The current sensor 142 can also include a housing 148 that includes the polymer composition as described that can house other components of the current sensor 142, e.g., resistors, capacitors, converters, processing chips, etc.

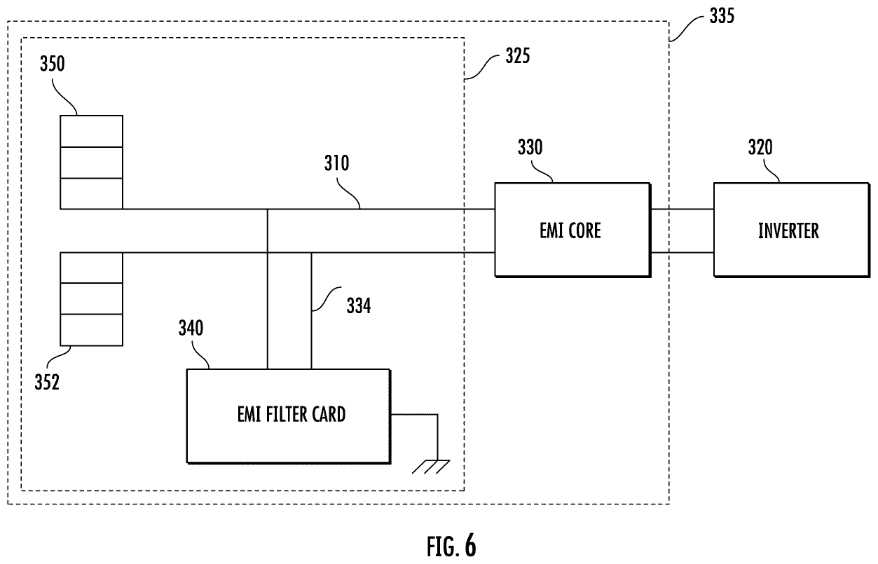

Another component of an electric vehicle as may incorporate the polymer compositions as described is an inverter system, one exemplary embodiment of which is illustrated in FIG. 6. The system includes an inverter module 320 and an interconnection system 335. The interconnection system 335 includes an Electromagnetic Interference (EMI) core 330 and an EMI filter apparatus 325. The inverter module 320 is coupled to the interconnection system 335 by a pair of bus bars 310. The EMI core 330 is located between the EMI filter apparatus 325 and the inverter module 320 and is in communication with the bus bars 310. The EMI filter apparatus 325 includes an EMI filter card 340 and a pair of bolts 350, 352 which include a positive terminal (+) bolt 350 and a negative terminal (−) bolt 352 for coupling to a power source, e.g., the battery assembly 124. The EMI core 330 is coupled to the bolts 350, 352 by the bus bars 310. The EMI filter card 340 is also coupled between ground and the bus bars 310 via a pair of wires 334. An inverter module 320 includes a number of transistors (not shown). Transistors in an inverter module 320 switch on and off relatively rapidly (e.g., 5 to 20 kHz). This switching tends to generate electrical switching noise. The electrical switching noise should ideally be contained inside the inverter module 320 and prevented from entering the rest of the electrical system to prevent interference with other electrical components in the vehicle.

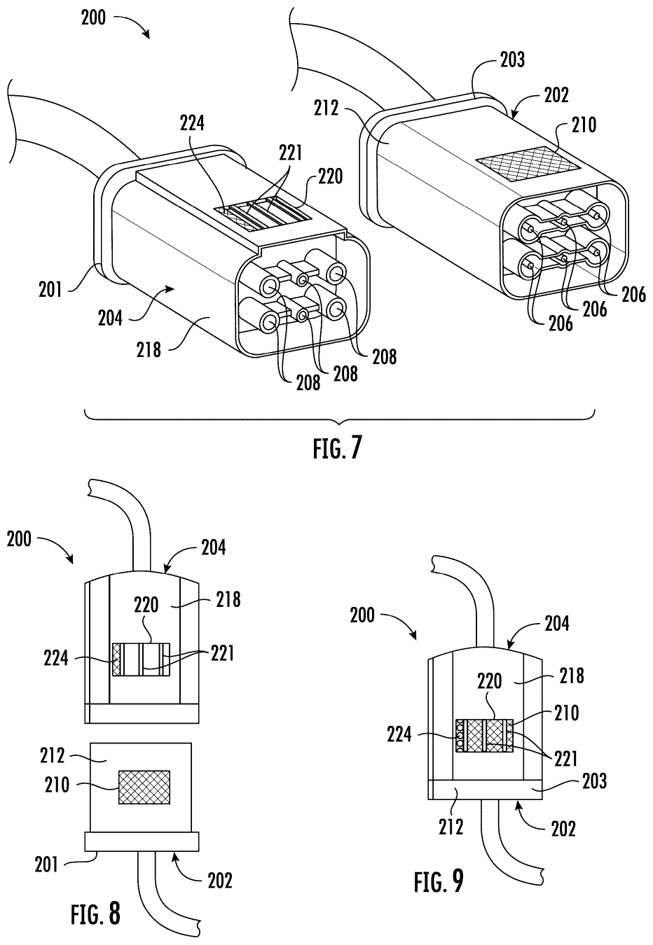

An inverter system can include several components that can incorporate a polymer composition as disclosed including, without limitation, the EMI filter apparatus 325, e.g., as a housing and/or internal support structures, an EMI filter card 340, the bus bars 310, as well as connectors employed within the system. For example, an electrical connector that includes the polymer composition as described herein may be employed in an inverter system as in FIG. 7 or within another portion of an electric vehicle. An electrical connector can in general include a first connector portion that contains at least one electrical contact and an insulating member that surrounds at least a portion of the connector portion. The insulating member may contain the polymer composition of the present invention. The first connector portion may be configured to mate with an opposing second connector portion that contains a receptacle for receiving the electrical contact. In such embodiments, the second connector portion may contain at least one receptacle configured to receive the electrical contact of the first connector portion and an insulating member that surrounds at least a portion of the second connector portion. The insulating member of the second connector portion may also contain the polymer composition of the present invention.

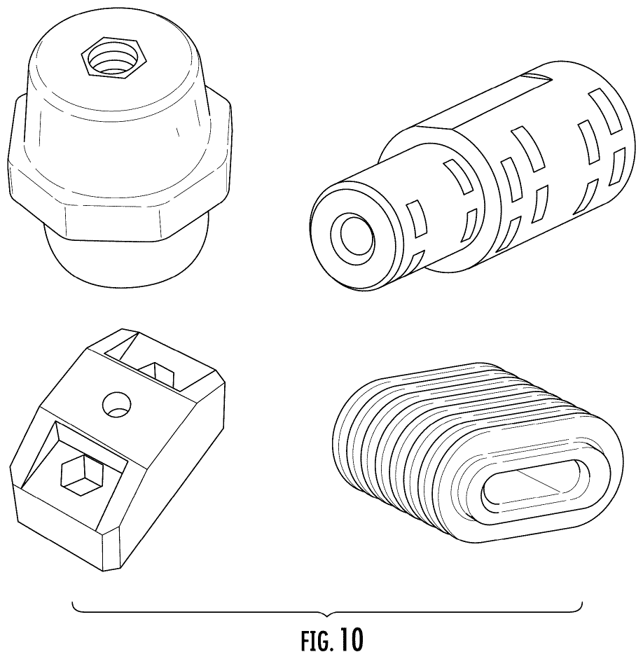

Referring to FIG. 7, FIG. 8, and FIG. 9, one particular embodiment of a connector 200 is shown for use in an electric vehicle, e.g., in an electric vehicle powertrain. The connector 200 contains a first connector portion 202 and a second connector portion 204. The first connector portion 202 may include one or more electrical pins 206 and the second connector portion 204 may include one or more receptacles 208 for receiving the electrical pins 206. A first insulator member 212 may extend from a base 203 of the first connecting portion 202 to surround the pins 206, and similarly, a second insulator member 218 may extend from a base 201 of the second connecting portion 204 to surround the receptacles 208. In certain cases, the periphery of the first insulator member 212 may extend beyond an end of the electrical pins 206 and the periphery of the second insulator member 218 may extend beyond an end of the receptacles 208. The base 203 and/or the first insulator member 212 of the first connector portion 202, as well as the base 201 and/or the second insulator member 218 of the second connector portion 204, may be formed from the polymer composition of the present invention.

Although by no means required, the first connector portion 202 may also include an identification mark 210 secured to or defined by the first protective member 212. The second connecting portion 204 may also optionally define an alignment window 220 sized according to the identification mark 210 to more easily determine when the portions are fully mated. For instance, the identification mark 210 may not be readable unless blockers 221 cover a portion of the identification mark 210. Optionally, the second connecting portion 204 may include a supplemental mark 224 located adjacent to the alignment window 220.

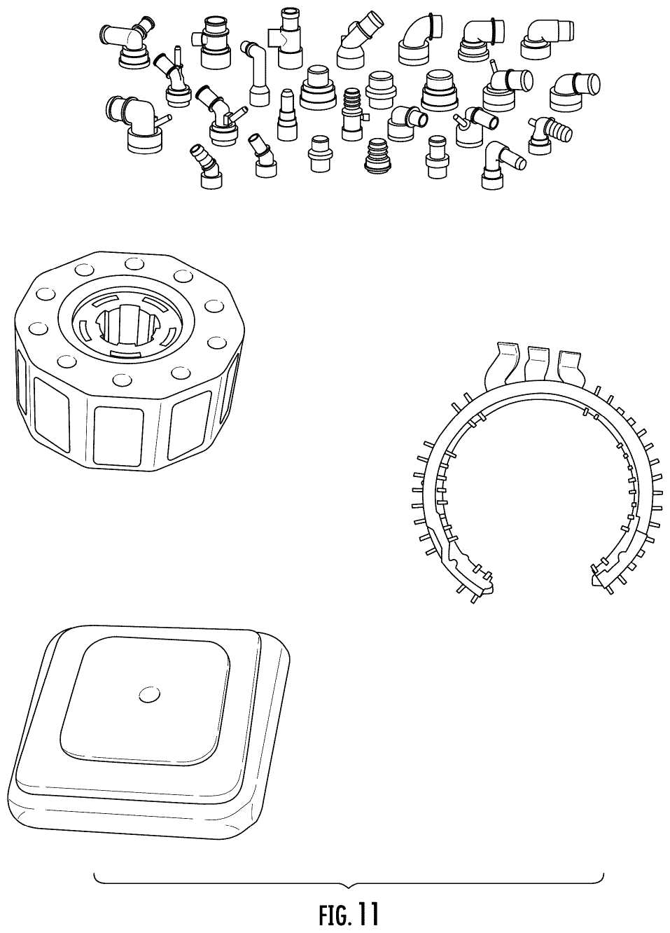

FIG. 10 and FIG. 11 illustrate yet other examples of components that may employ the polymer composition of the present invention, such as spacers, connectors, insulators and supports as shown in FIG. 10 and that can be formed from the polymer composition. Components as may incorporate a polymer composition illustrated in FIG. 11 include quick connects, tees, and interconnectors, a plurality of which are illustrated at the top of FIG. 11; brushless direct current motors (middle left of FIG. 11), e.g., sealing rings, housings, supports, etc. of a motor; guide rails (middle right of FIG. 11, also illustrating additional examples of busbars in the image); and battery sealing rings (bottom of FIG. 11).

Systems that can employ the polymer composition of the present invention are in no way limited to only electrical systems. For example, a thermal management system can also beneficially incorporate the polymer composition. A thermal management system of an electric vehicle can generally include multiple different subsystems such as, without limitation, a power train subsystem, a refrigeration subsystem, a battery cooling subsystem, and a heating, ventilation, and cooling (HVAC) subsystem. In some embodiments, one or more subsystems of a thermal management system may in fluid communication with one another, thus allowing hot heat transfer medium to flow from the high temperature circuit into the low temperature circuit, and cooler heat transfer medium to flow from the low temperature circuit into the high temperature circuit.

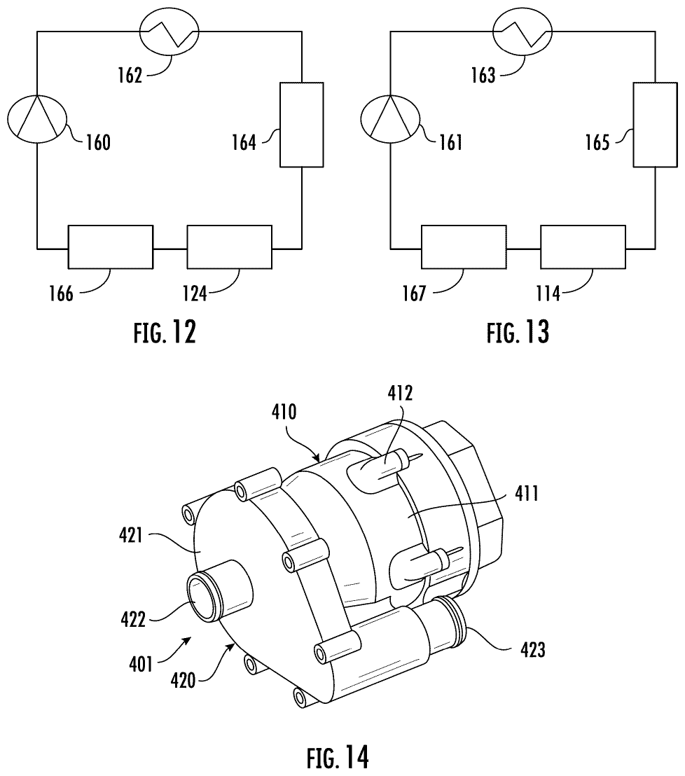

By way of example, FIG. 12 illustrates a first temperature control loop and FIG. 13 illustrates a second temperature control loop as may be found in electric vehicles, each of which designed for different subsystems and each of which including one or more components that can employ a polymer compositions of the invention. By way of example, a first temperature control loop in a typical electric vehicle (FIG. 12) can include a heat transfer medium (e.g., water) that is pumped through the loop via a suitable pump 160, e.g., an electric water pump, and cooled via heat transfer with a refrigerant in a heat exchanger 163 (e.g., an energy storage system (ESS) heat exchanger) as well as a radiator/reservoir 164. Additionally, the loop can include a heater 166 e.g., a positive temperature coefficient (PTC) heater, which can ensure that the temperature of the system can be maintained within its preferred operating range regardless of the ambient temperature, and the battery assembly 124. A second temperature control loop (FIG. 13) can also include a heat transfer medium that can be the same or differ from the heat transfer medium of another subsystem. The heat transfer medium of the second temperature control loop can be pumped through the loop with a suitable pump 161, a heat exchanger 163, and a radiator/reservoir 165. A high temperature control loop can be utilized in cooling the power electronics 167 as well as the electric machines 114 of the vehicle.

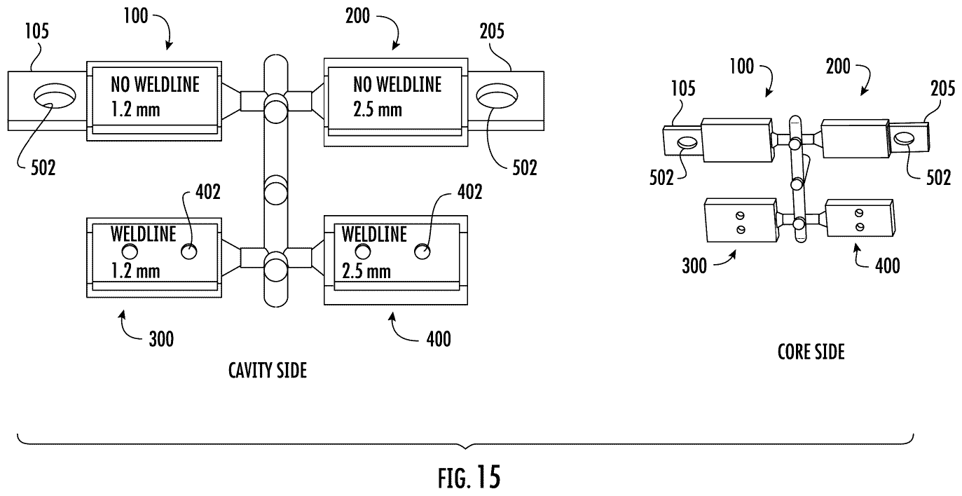

One example of a component of a heat management system as may incorporate the polymer composition of the invention is a coolant pump, e.g., an electric water pump, an example of which is illustrated in FIG. 14. As shown, the electric water pump 401 includes an electric motor 410 as a drive source and a hydraulic portion 420 for generating coolant suction and discharge forces. The motor 410 and associated components are retained with in the motor housing 411. The hydraulic portion 420 includes a volute casing 421 that generally includes a spiral flow space, an inlet 422, and outlet 423, and an impeller (not shown) rotated by the electric motor 410. The pump 401 has an interface including a mechanical seal (not shown), for sealing and separating the water flow space and the motor chamber. Generally, a mounting portion 412 is provided on the motor housing 411 to mount the pump 401 in the vehicle. Components of an electric pump 401 such as housings, casings, interfaces, etc. can incorporate a polymer composition of the invention.

The present invention may be better understood with reference to the following examples.

### Test Methods

Melt Viscosity: The melt viscosity (Pa-s) may be determined in accordance with ISO 11443:2021 at a shear rate of 400 s⁻¹ and using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod was 233.4 mm. The melt viscosity is typically determined at a temperature of 310° C.

Tensile Modulus, Tensile Stress at Break, and Tensile strain at Break: Tensile properties may be tested according to ISO 527-2/1A: 2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 5 mm/min.

Flexural Modulus, Flexural Stress at Break, and Flexural Stress: Flexural properties may be tested according to ISO 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO 179-1:2010) (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C.

Comparative Tracking Index (“CTI”): The comparative tracking index (CTI) may be determined in accordance with International Standard IEC 60112-2003 to provide a quantitative indication of the ability of a composition to perform as an electrical insulating material under wet and/or contaminated conditions. In determining the CTI rating of a composition, two electrodes are placed on a molded test specimen.

A voltage differential is then established between the electrodes while a 0.1% aqueous ammonium chloride solution is dropped onto a test specimen. The maximum voltage at which five (5) specimens withstand the test period for 50 drops without failure is determined. The test voltages range from 100 to 600 V in 25 V increments. The numerical value of the voltage that causes failure with the application of fifty (50) drops of the electrolyte is the “comparative tracking index.” The value provides an indication of the relative track resistance of the material. According to UL746A, a nominal part thickness of 3 mm is considered representative of performance at other thicknesses.

Flame Retardancy: The flame retarding efficacy may be determined according to the UL 94 Vertical Burn Test procedure of the “Tests for Flammability of Plastic Materials for Parts in Devices and Appliances” (edition date of Feb. 28, 2023), which is now harmonized with IEC 60707, 60695-11-10 and 60695-11-20 and ISO 9772 and 9773. In the test, two sets of five samples (ten total) may be employed that have a length of 125 mm, width of 13 mm, and a thickness in the desired range (e.g., 0.2 mm, 0.4 mm, 0.8 mm, or 1.5 mm). The two sets of samples may be conditioned before and after aging. For unaged testing, each thickness is tested after conditioning for 48 hours at 23° C. and 50% relative humidity. For aged testing, five (5) samples of each thickness are tested after conditioning for 168 hours at a temperature of 70° C. and then cooled in a dessicator for at least 4 hours at room temperature. To initiate testing, the sample holder may be positioned so that the sample is held at least 425 mm above a working surface. Cotton batting (e.g., less than 6 mm in thickness) may be placed directly below the clamp to ensure that an area of 50 mm×50 mm is covered. The top 6 mm of the specimen may be placed vertically in the clamp and the holder may be adjusted so that the bottom edge of the specimen is 300±10 mm above the cotton batting. Once in position, the flame may be applied for ten (10) seconds and then removed until flaming stops, at which time the flame may be reapplied for another ten (10) seconds and then removed. If dripping is present, it should fall onto the cotton batting underneath the specimen. When the flaming burn stops, the time is recorded as “t1” and the burner is then reapplied. The time at which flaming burn ends is recorded as “12.” The time at which the glowing burn ends is recorded as “t3.” The results are then compared to the UL94 flame ratings based on the criteria provided in the table below.

| | | | | # Drips of | | |
|---|---|---|---|---|---|---|
| | Burning Time | | | Burning | # Drips of | Combustion Up |
| | of Individual | Total | Burning and | Specimen | Burning | to Holding Clamp |
| | Specimen (after | Flame | Afterglow | (without | Specimen | (specimens |
| | 1^{st} and 2^{nd} flame | Time(s) | Times | ignition of | (ignition of | completely |
| Rating | applications) (s) | (t1 + t2) | (t2 + t3) | cotton batting) | cotton batting) | burned) |
| V-2 | ≤30 | ≤250 | ≤60 | ≥0 | ≥0 | No |
| V-1 | ≤30 | ≤250 | ≤60 | ≥0 | 0 | No |
| V-0 | ≤10 | ≤50 | ≤30 | ≥0 | 0 | No |

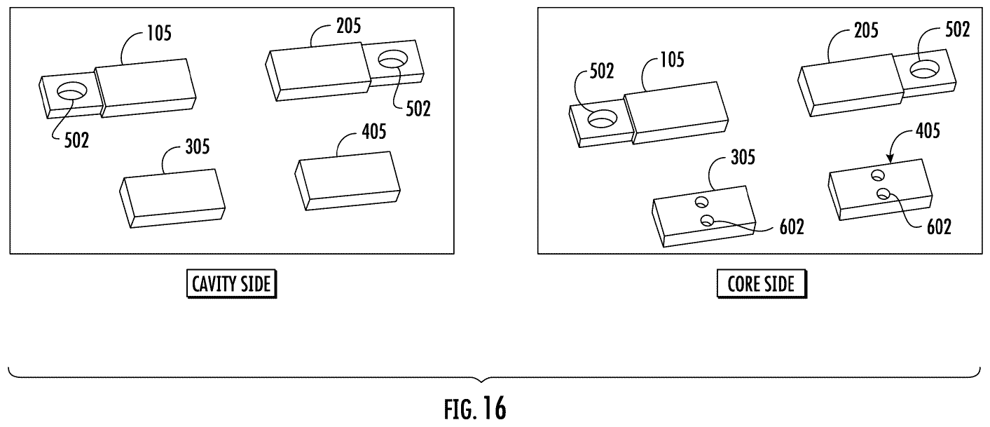

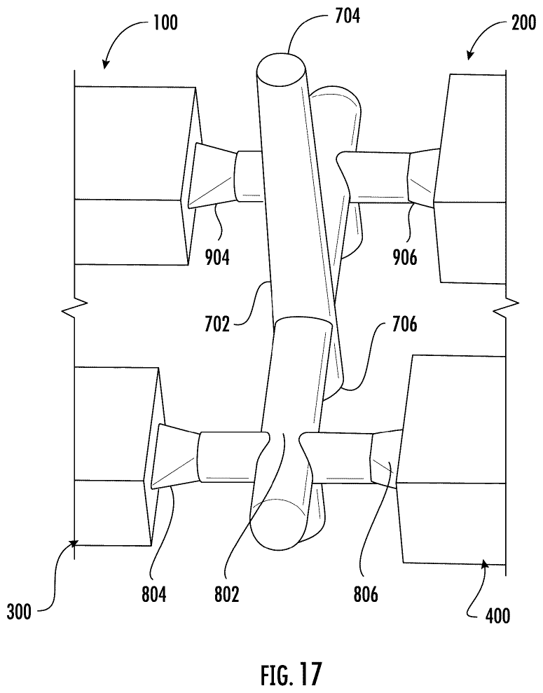

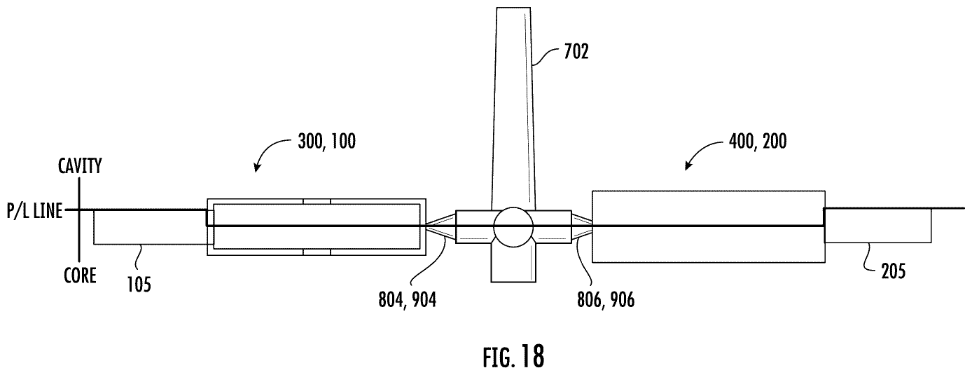

Thermal Shock Resistance: To test thermal shock resistance, four (4) types of sample components are initially formed using the molds and inserts shown in FIGS. 15-18. As shown in FIG. 15, a first mold 100 is shaped to result in a plastic thickness of 1.2 mm and a part size of 63.8 mm×20 mm×10.4 mm; a second mold 200 is shaped to result in a plastic thickness of 2.5 mm and a part size of 65.1 mm×22.6 mm×13 mm; a third mold 300 is shaped to result in a plastic thickness of 1.2 mm and a part size of 40 mm×20 mm×10.4 mm; and a fourth mold 400 is shaped to result in a plastic thickness of 42.6 mm×22.6 mm×13 mm. Two circular bores 402 are formed on the cavity side of each of the molds 300 and 400, parallel to the longitudinal edge of the molds. The bores 402 have a diameter of 3.5 mm and are recessed into the cavity side of the molds. The first and second molds 100 and 200 contain metal inserts 105 and 205 (see FIG. 16), respectively, which are formed from an AISI H13/440C stainless steel sheet having a size of 62.6 mm×18 mm×18 mm that is inserted into the mold in a manner such that no weldline is formed. The inserts 105 and 205 have a single circular bore 502 at their respective ends having a diameter of 5 mm. The third and fourth molds 300 and 400 likewise contain metal inserts 305 and 405 (see FIG. 16), respectively, which are formed from an AISI H13/440C stainless steel sheet having a size of 37.6 mm×18 mm×18 mm. As shown in FIG. 16, each of the metal inserts 305 and 405 contain two circular bores 602 that are aligned parallel to the transverse edge of the inserts and recessed into the core side of each respective insert. The bores 602 have a diameter of 2.0 mm and are recessed into the core side of the inert by a depth of 5 mm. When inserted into the molds 300 and 400, a weldline is formed at a line where two flow fronts meet such that there is an inability of the flow fronts to “knit” or “weld” together during the molding process.

Referring to FIGS. 15, 17, and 18, a sample component may be formed using the molds described above by initially passing a polymer composition through a sprue 702 having an upper end 704 with a small diameter (i.e., 6 mm) and a lower end 706 with a diameter greater than the upper end 704 (i.e., 8 mm). The polymer composition may flow through the sprue 702 into a first runner 802 (diameter of 7 mm) and through a gate 804 for the third mold 300 that has a size of 0.8×10 mm and through a gate 806 for the fourth mold 400 that has a size of 1.7×10 mm. The polymer composition may likewise flow through the sprue 702 into a second runner 902 (diameter of 6 mm) and through a gate 904 for the first mold 100 that has a size of 0.8×10 mm and through a gate 906 for the fourth mold 400 that has a size of 1.7×10 mm. The draft angle for each side of the molds is 1.5°. When forming molded parts, the processing conditions may be selected as is known to those skilled in the art. For example, the melt and nozzle temperature may be 320° C., the injection pressure may be 1250 bar, the peak pressure may be 1146 bar (e.g., for mold 100) and 1120 (e.g., for mold 300), the injection speed may be 80 mm/s and the injection time may be about 0.25 s, the hold pressure may be about 800 bar, the cooling time may be about 15 s, and the total cycle time may be about 23 s.

A set of twenty (20) sample components may be formed using each of the molds described above. The sample components may then be subjected to a first heating cycle within a thermal shock chamber having a hot zone and a cold zone, such as those commercially available under the name “ShockEvent T/120/V2” from Weisstechnik. The hot zone may be heated to a temperature of 140° C. and the cold zone may be cooled to a temperature of −40° C. To initiate the first heating cycle, the sample components are placed within the hot zone for 30 minutes and then a product carrier within the chamber moves the sample components from the hot zone to the cold zone for an additional 30 minutes. In this manner, the total time of the first cycle is 1 hour. 24 cycles are conducted each day and 1 hour for each cycle. During the first two weeks, the sample components are visually observed for cracking once a day, and thereafter, the sample components are visually observed for cracking twice per week until all twenty (20) samples crack or a full set of cycles is achieved, which may be either 1,500 or 3,000 cycles depending on the testing protocol. When the first sample cracks, the number of cycles achieved prior to cracking is recorded as the “thermal shock resistance value.” If a full set of cycles (1,500 or 3,000) is achieved without all samples cracking, the “thermal shock resistance value” is simply recorded as “>1,500” or “>3,000”, depending on the particular testing protocol.

### Comparative Example 1

Comparative Example 1 was melt mixed using a 32 mm Coperion co-rotating, fully-intermeshing, twin-screw extruder and include various concentrations of a polyarylene sulfide (PPS 2), impact modifier (Impact Modifier 2), glass fibers, siloxane polymer, organosilane compound, Mineral Particles 1, lubricant, and colorant. PPS 2had a melt flow index of about 1,000 g/10 minutes. Impact Modifier 2 was a random terpolymer of ethylene, acrylic ester, and glycidyl methacrylate having 7.25 wt. % glycidyl methacrylate content. Mineral Particles 1 were calcium carbonate particles having a median particle size of about 3.2 μm and a moisture content of less than 0.2%. The siloxane polymer was an UHMW functionalized siloxane polymer provided as a masterbatch at 50% siloxane content and 50% resin content. The organosilane compound was 3-aminopropyltriethoxysilane. The formulation is set forth in more detail in the table below.

Comp. Ex. 1

| | Wt. % | Parts |
|---|---|---|
| PPS 2 | 44.6 | 100 |
| Glass Fibers | 38 | 85 |
| Mineral Particles 1 | 9 | 20 |
| Impact Modifier 2 | 6 | 13 |
| Siloxane Polymer | 0.2 | 0.4 |
| Lubricant | 0.2 | 0.4 |
| Colorant | 2 | 4 |

Once formed, the resulting composition was then injected molded and tested for various properties as described above. The results are set forth below.

| | Ex. 4 |
|---|---|
| Tensile Modulus (MPa) | 13,500 |
| Tensile Strength (MPa) | 155 |
| Tensile Break Strain (%) | 1.6 |
| Flexural Modulus (MPa) | 14,000 |
| Flexural Strength (MPa) | 240 |
| Charpy Notched at 23° C. | 10 |
| (kJ/m²) | |
| Thermal Shock Resistance Value | 200 |

### Examples 1-3

Examples 1-3 were melt mixed using a 32 mm Coperion co-rotating, fully-intermeshing, twin-screw extruder and include various concentrations of a polyarylene sulfide (PPS 1), impact modifier (Impact Modifier 1), glass fibers, siloxane polymer, organosilane compound, mineral particles (Mineral Particles 1, Mineral Particles 2, and Mineral Particles 3), and colorant. PPS 1 had a melt flow index of about 500 g/10 minutes. Impact Modifier 1 was a random copolymer of ethylene and glycidyl methacrylate having 8 wt. % glycidyl methacrylate content and a melt flow index of 5g/10 min at 190° C. Mineral Particles 2 were superfine wollastonite particles having a median diameter of 2 μm. Mineral Particles 3 were calcium carbonate particles having a stearic acid surface coating and having a median particle size of about 2.5 μm and a moisture content of less than 0.1%. The siloxane polymer and organosilane compound were the same as used in Comparative Example 1. The formulations of each Example are set forth in more detail in the table below.

| | Ex. 1 | | Ex. 2 | | Ex. 3 | |
|---|---|---|---|---|---|---|
| | Wt. % | Parts | Wt. % | Parts | Wt. % | Parts |
| PPS 1 | 43.2 | 100 | 43.2 | 100 | 43.2 | 100 |
| Glass Fibers | 35 | 81 | 35 | 81 | 35 | 81 |
| Mineral Particles 1 | 15 | 34.7 | — | — | — | — |
| Mineral Particles 2 | — | — | 15 | 34.7 | — | — |
| Mineral Particles 3 | — | — | — | — | 15 | 34.7 |
| Impact Modifier 1 | 5 | 11.6 | 5 | 11.6 | 5 | 11.6 |
| Siloxane Polymer | 1 | 2.3 | 1 | 2.3 | 1 | 2.3 |
| Organosilane | 0.3 | 0.7 | 0.3 | 0.7 | 0.3 | 0.7 |
| Compound | | | | | | |
| Colorant | 0.5 | 1.2 | 0.5 | 1.2 | 0.5 | 1.2 |

Once formed, the resulting compositions were then injected molded and tested for various properties as described above. The results are set forth below.

| | Ex. 1 | Ex. 2 | Ex. 3 |
|---|---|---|---|
| Melt Viscosity (kpoise) at 400 s⁻¹ | 4.5 | 4.0 | 4.1 |
| Tensile Modulus (MPa) | 16,000 | 16,200 | 16,200 |
| Tensile Strength (MPa) | 155 | 161 | 172 |
| Tensile Break Strain (%) | 1.5 | 1.6 | 1.8 |
| Flexural Modulus (MPa) | 16,000 | 16,200 | 16,200 |
| Flexural Strength (MPa) | 245 | 255 | 270 |
| Flexural Break Strain (%) | 1.7 | 1.9 | 2.0 |
| Charpy Notched at 23° C. | 8.5 | 9.8 | 10.2 |
| (kJ/m²) | | | |
| Thermal Shock Resistance Value | 900 | 1200 | 1500 |
| CTI (V) | 150 | 175 | 175 |
| Flame Retardancy - Thickness | 2.5 mm | 1.5 mm | 1.5 mm |
| at V0 Rating | | | |

### Example 4

Example 5 was melt mixed using a 32 mm Coperion co-rotating, fully-intermeshing, twin-screw extruder and include various concentrations of PPS 2, Impact Modifier 2, glass fibers, siloxane polymer, organosilane compound, Mineral Particles 4, and colorant. The siloxane polymer and organosilane compound were the same as employed in Examples 1-3. The formulation is set forth in more detail in the table below.

Ex. 4

| | Wt. % | Parts |
|---|---|---|
| PPS 1 | 42 | 100 |
| Glass Fibers | 38 | 90 |
| Mineral Particles 1 | 9 | 21 |
| Impact Modifier 2 | 7 | 17 |
| Siloxane Polymer | 1 | 2 |
| Organosilane Compound | 0.2 | 0.5 |
| Colorant | 2.5 | 6 |

Once formed, the resulting composition was then injected molded and tested for various properties as described above. The results are set forth below.

| | Ex. 4 |
|---|---|
| Tensile Modulus (MPa) | 13,500 |
| Tensile Strength (MPa) | 160 |
| Tensile Break Strain (%) | 1.7 |
| Flexural Modulus (MPa) | 13,500 |
| Flexural Strength (MPa) | 250 |
| Charpy Notched at 23° C. | 11 |
| (kJ/m²) | |
| Flame Retardancy - Thickness | 2.5 mm |
| at V0 Rating | |
| Thermal Shock Resistance Value | 1,200 |

### Example 5

Example 5 was melt mixed using a 32 mm Coperion co-rotating, fully-intermeshing, twin-screw extruder and include various concentrations of PPS 2, Impact Modifier 1, glass fibers, siloxane polymer, organosilane compound, Mineral Particles 4 and colorant. The siloxane polymer and organosilane compound were the same as employed in Examples 1-3. The formulation is set forth in more detail in the table below.

Ex. 5

| | Wt. % | Parts |
|---|---|---|
| PPS 2 | 42 | 100 |
| Glass Fibers | 38 | 90 |
| Mineral Particles 1 | 9 | 21 |
| Impact Modifier 1 | 4 | 9.5 |
| Siloxane Polymer | 1 | 2 |
| Organosilane Compound | 0.2 | 0.5 |
| Colorant | 2.5 | 6 |

Once formed, the resulting composition was then injected molded and tested for various properties as described above. The results are set forth below.

| | Ex. 5 |
|---|---|
| Tensile Modulus (MPa) | 16,000 |
| Tensile Strength (MPa) | 170 |
| Tensile Break Strain (%) | 1.7 |
| Flexural Modulus (MPa) | 15,500 |
| Flexural Strength (MPa) | 260 |
| Charpy Notched at 23° C. | 11 |
| (kJ/m²) | |
| Flame Retardancy - Thickness | 1.5 mm |
| at V0 Rating | |
| Thermal Shock Resistance Value | 1,000 |

### Example 6

Example 6 was melt mixed using a 32 mm Coperion co-rotating, fully-intermeshing, twin-screw extruder and include various concentrations of PPS 2, Impact Modifier 1, glass fibers, siloxane polymer, organosilane compound, Mineral Particles 3, and colorant. The siloxane polymer and organosilane compound were the same as employed in Examples 1-3. The formulation is set forth in more detail in the table below.

Ex. 6

| | Wt. % | Parts |
|---|---|---|
| PPS 2 | 42.5 | 100 |
| Glass Fibers | 40 | 94 |
| Mineral Particles 3 | 10 | 23.5 |
| Impact Modifier 1 | 4 | 9 |
| Siloxane Polymer | 0.8 | 2 |
| Organosilane Compound | 0.2 | 0.5 |
| Colorant | 2.5 | 6 |

Once formed, the resulting composition was then injected molded and tested for thermal shock. The thermal shock resistance value was 1,000.

### Example 7

Example 7 was melt mixed using a 32 mm Coperion co-rotating, fully-intermeshing, twin-screw extruder and include various concentrations of PPS 2, PPS 3, Impact Modifier 1, glass fibers, siloxane polymer, organosilane compound, Mineral Particles 3, and colorant. PPS 3 had a melt flow index of 500 g/10 min such that the overall melt flow index of the resulting polymer matrix was about 735 g/10 min. The siloxane polymer and organosilane compound were the same as employed in Examples 1-3. The formulation is set forth in more detail in the table below.

Ex. 7

| | Wt. % | Parts |
|---|---|---|
| PPS 2 | 20 | 100 |
| PPS 3 | 22.5 | |
| Glass Fibers | 40 | 94 |
| Mineral Particles 3 | 10 | 23.5 |
| Impact Modifier 1 | 4 | 9 |
| Siloxane Polymer | 0.8 | 2 |
| Organosilane Compound | 0.2 | 0.5 |
| Colorant | 2.5 | 6 |

Once formed, the resulting composition was then injected molded and tested for various properties as described above. The results are set forth below.

| | Ex. 7 |
|---|---|
| Tensile Modulus (MPa) | 16,000 |
| Tensile Strength (MPa) | 170 |
| Tensile Break Strain (%) | 1.7 |
| Flexural Modulus (MPa) | 15,500 |
| Flexural Strength (MPa) | 260 |
| Charpy Notched at 23° C. | 10 |
| (kJ/m²) | |
| Flame Retardancy - Thickness | 1.5 mm |
| at V0 Rating | |
| Thermal Shock Resistance Value | 1,500 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A polymer composition comprising an impact modifier, mineral particles, and reinforcing fibers dispersed within a polymer matrix, wherein the polymer matrix contains a polyarylene sulfide and exhibits a melt flow index of from about 500 to about 1,000 grams per 10 minutes as determined in accordance with ASTM D1238-13 at a load of 2.16 kg and temperature of 190° C., wherein the weight ratio of the reinforcing fibers to the mineral particles is about 2 or more, and further wherein the polymer composition exhibits a thermal shock resistance value of about 800 or more.

2. The polymer composition of claim 1, wherein the mineral particles include calcium carbonate particles.

3. The polymer composition of claim 1, wherein the mineral particles contain a surface treatment agent.

4. The polymer composition of claim 3, wherein the surface treatment agent contains a fatty acid.

5. The polymer composition of claim 1, wherein the mineral particles have a median particle size of about 0.5 to about 10 micrometers.

6. The polymer composition of claim 1, wherein the mineral particles have a moisture content of about 0.5% or less.

7. The polymer composition of claim 1, wherein the reinforcing fibers include glass fibers.

8. The polymer composition of claim 1, wherein the reinforcing fibers are present in an amount of from about 50 to about 150 parts by weight per 100 parts by weight of the polymer matrix and the mineral particles are present in an amount of from about 10 to about 50 parts by weight per 100 parts by weight of the polymer matrix.

9. The polymer composition of claim 1, further comprising an ultrahigh molecular weight siloxane polymer having a weight average molecular weight of about 100,000 grams per mole or more.

10. The polymer composition of claim 1, further comprising an organosilane compound.

11. The polymer composition of claim 1, wherein the impact modifier is present in an amount of from about 1 to about 30 parts by weight per 100 parts by weight of the polymer matrix.

12. The polymer composition of claim 1, wherein the impact modifier includes an epoxy-functionalized monomeric unit.

13. The polymer composition of claim 1, wherein the polymer matrix constitutes from about 10 wt. % to about 70 wt. % of the polymer composition.

14. The polymer composition of claim 1, wherein the polymer matrix contains a first polyarylene sulfide and a second polyarylene sulfide, wherein the ratio of the melt flow index of the first polyarylene sulfide to the melt flow index of the second polyarylene sulfide is from about 1.5 to about 3.

15. The polymer composition of claim 1, wherein the polymer composition exhibits a V-0 rating as determined in accordance with UL94 testing at a thickness of 1.5 mm.

16. A composite structure comprising a metal component in contact with a resinous component that includes the polymer composition of claim 1.

17. An electric vehicle comprising a powertrain that includes at least one electric propulsion source and a transmission that is connected to the propulsion source via at least one power electronics module, wherein the electric vehicle comprises the composite structure of claim 16.

18. The electric vehicle of claim 17, wherein the electric vehicle comprises an electrical component comprising the composite structure.

19. The electric vehicle of claim 18, wherein the electrical component comprises a busbar, current sensor, inverter filter, electrical connector, a brushless direct current motor, a guide ring, a battery cell sealing ring, or a combination thereof.

20. The electric vehicle of claim 17, wherein the electric vehicle comprises a thermal management system component comprising the polymer composition.
